(19) United States
(12) Patent Application Publication
(10) Pub. No.: US 2026/0048930 A1
(43) Pub. Date: Feb. 19, 2026

(54) FABRIC ASSEMBLY AND METHOD OF SPLICING SAME

(71) Applicant: Mesa Industries, Inc., Cincinnati, OH (US)

(72) Inventors: Adam K. Vance, Cincinnati, OH (US); Daniel S. Smith, Newport, KY (US); Brady M. Stefancik, Cincinnati, OH (US)

(21) Appl. No.: 19/301,045

(22) Filed: Aug. 15, 2025

Related U.S. Application Data
(60) Provisional application No. 63/683,920, filed on Aug. 16, 2024.

(51) Int. Cl. B65D 88/34; B29C 65/00; B29C 65/02; B29C 65/82; B29K 23/00; B29K 67/00; B29L 31/00; B65D 90/28

(52) U.S. Cl. CPC B65D 88/34; B29C 65/02; B29C 65/82; B29C 66/13; B29C 66/43; B29C 66/71; B29C 66/729; B65D 90/28; B29K 2023/0633; B29K 2023/0683; B29K 2067/00; B29L 2031/7126

(57) ABSTRACT

A fabric assembly and method of manufacturing a spliced liquid-mounted seal sheet is provided. The method includes overlapping a first fabric layer and a second fabric layer, wherein at least one of the first fabric layer or the second fabric layer defines an opening having a shaft defining a channel positioned therethrough, the shaft housing a valve having an open position and a closed position, wherein the valve is configured to allow a fluid through the channel in a first direction while the valve is in the open position, and the valve prevents the fluid through the channel while the valve is in the close position. The method further includes splicing the first fabric layer to the second fabric layer to form a spliced fabric composite comprising an interior pocket space defined by the first fabric layer and the second fabric layer.

### PRIORITY

This application claims priority of U.S. Provisional Patent Application No. 63/683,920, entitled “Fabric Assembly and Method of Splicing Same,” filed Aug. 16, 2024, the disclosure of which is hereby incorporated by reference.

### TECHNICAL FIELD

The present invention relates generally to a fabric assembly and related methods and, more particularly, to a fabric assembly and method of splicing same for storage of a petroleum product.

### BACKGROUND

Storage systems for a petroleum product, such as crude oil and petrochemicals, generally contain large quantities of fluid, including liquid and gas, at various volumes as this petroleum product is added and/or removed from a storage tank during use. Such storage tanks are subject to harsh environments created at least in part by the petroleum product as well as the desire for durable and effective sealing.

By way of example, in the above ground storage tank industry, a floating roof is incorporated into many tanks that store particularly volatile petroleum-based compounds. The floating roof sits on top of the fluid stored in the tank, as the fluid rises and falls in the tank, the floating roof moves accordingly. The floating roof typically does not contact the shell or wall of the tank such that a “rim space” is left as a gap between the floating roof and the tank wall. A method to provide sealing for this rim space is to utilize a liquid mounted foam log. The liquid mounted foam log rests on the surface of the fluid and occupies the rim space between the floating roof and the tank wall. As the rim space expands and contracts, the foam log expands and contracts into the space, providing a generally constant and continuous seal about the tank wall.

In some instances, the foam log seal may fail at a vapor fabric barrier. When this vapor barrier fabric fails (e.g., such as through abrasion, cuts, and/or tears), the petroleum product stored within the storage tank soaks into a foam material of the foam log. Once sufficiently soaked with the petroleum product, the foam material loses its resiliency and, in turn, loses its effectiveness to seal within the storage tank. Additionally, the foam material soaked with the petroleum product will continue to create emissions when the storage tank is emptied, creating additional environment hazard and becoming an environmental disposal problem.

By way of further example, material and/or assembly inconsistencies in seals, such as those discussed above, may also reduce their useful life. While inspection of individual parts and materials prior to assembly proves helpful in identifying initial issues at a relatively low cost, additional inspections after seal installation may be relatively costly and time consuming to correct.

Accordingly, there is a need for a seal that addresses the present challenges such as those discussed above.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a view of a tube and nut for a valve assembly located through a fabric layer.

FIG. 2 depicts a view of the assembled valve assembly through a first layer of fabric, and a second layer of fabric underneath the first layer of fabric;

FIG. 3 depicts a view of the fabric layers from FIG. 2 with additional fabric to prepare for splicing the layers together;

FIG. 4 depicts a view of the fabric layers from FIG. 3 after splicing the fabric layers together to form a spliced fabric composite;

FIG. 5 depicts a view of the spliced fabric layers after a quality assurance test to check for leaks in the fabric layers;

FIG. 6A depicts a top view of a spliced fabric composite after splicing together two fabric layers;

FIG. 6B depicts a cross-sectional view of a spliced fabric composite after splicing together two fabric layers;

FIG. 7A depicts a schematic exploded view of the valve assembly and a fabric layer to be used in the spliced fabric composite; and

FIG. 7B depicts a perspective view of an example spliced fabric composite after a quality test has been performed.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

For clarity of disclosure, to the extent that such terms may be used herein, the terms “vertical,” “horizontal,” and “radial” are defined herein relative to a circular storage tank positioned on a ground surface. In this respect, “lower vertical direction” is toward to the ground, “upper vertical direction” is away from the ground, “left horizontal direction” is circumferentially left parallel to the ground, “right horizontal direction” is circumferentially right parallel to the ground, and “radial direction” is toward or away from an outer wall of the storage tank relative to a central axis of the storage tank. It will be further appreciated that, for convenience and clarity, spatial terms such as “upper,” “lower,” “lateral,” “inner,” “outer,” “leftward,” “rightward,” and “central” also are used herein for reference to relative positions and directions. Such terms may be used below with reference to views as illustrated for clarity and are not intended to limit the invention described herein.

### I. FIRST EXAMPLE OF A SPLICED FABRIC COMPOSITE

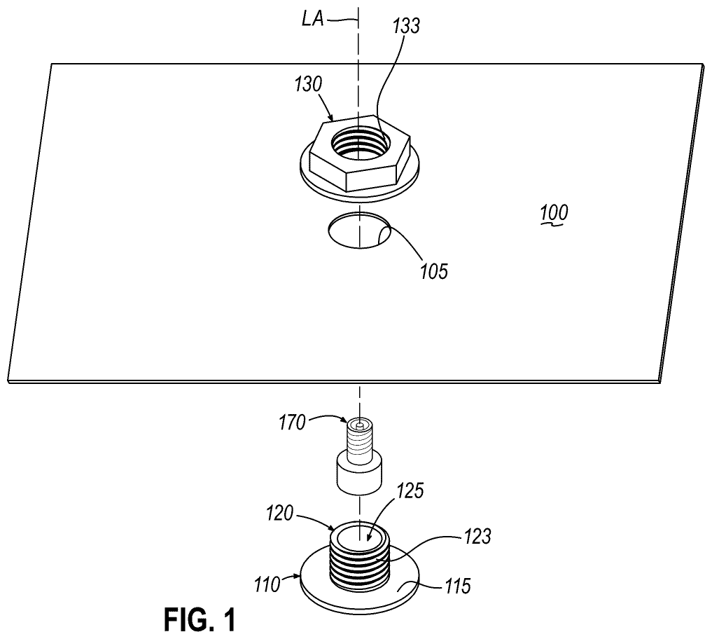

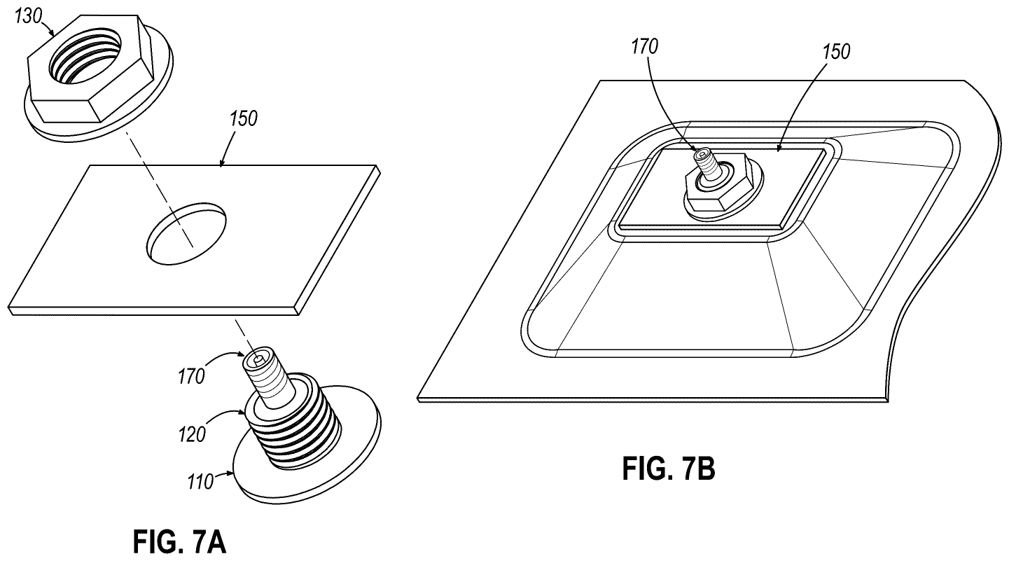

FIGS. 1 and 7A-7B show a first example of a fabric layer (100) to be used in a spliced fabric composite. The fabric layer includes an opening (105) into which a shaft (120) of a tube (110) is inserted therethrough. The shaft defines a channel (125), and the channel (125) provides fluid communication between opposing faces of the fabric layer (100). While the shaft (120) is shown as generally cylindrical in FIG. 1, the shaft may be any desired shape that defines the channel (125). The shaft (120) includes an exterior threading (123) configured to threadably mate is a corresponding interior threading (133) of a nut (130). In addition to the shaft (120), the tube (110) furthermore includes a base (115) that projects transversely from a longitudinal axis (LA) that runs through the middle of the channel (125). The tube (110) is sized such that the tube (110) is prevented from navigating completely through the opening (105) by the base (115) contacting a face of the fabric layer (100).

With continued reference to FIGS. 7A-7B, a barrier layer (150) of material may be added on an outer periphery of the shaft (120). The barrier layer (150) covers any portion of the opening in the fabric layer that is not included in the channel to prevent fluid communication therethrough.

With continued reference to FIG. 7B, a valve (170) is also present within the channel (125). The valve (170) includes an open and a closed position. In the open position, fluids, such as air or soapy material may travel through the channel, via the open valve (170), and reach an interior pocket space defined by the fabric layers of the spliced fabric composite. In the closed position, the channel is sealed from fluid outside of the interior pocket space from entering the interior pocket space via the valve (170), and vice versa. While the valve (170) is in the open position, to prevent backflow of fluid entering the pocket space, the fluid may be pressurized such that a pressure drop exists from outside of the pocket space to inside the pocket space.

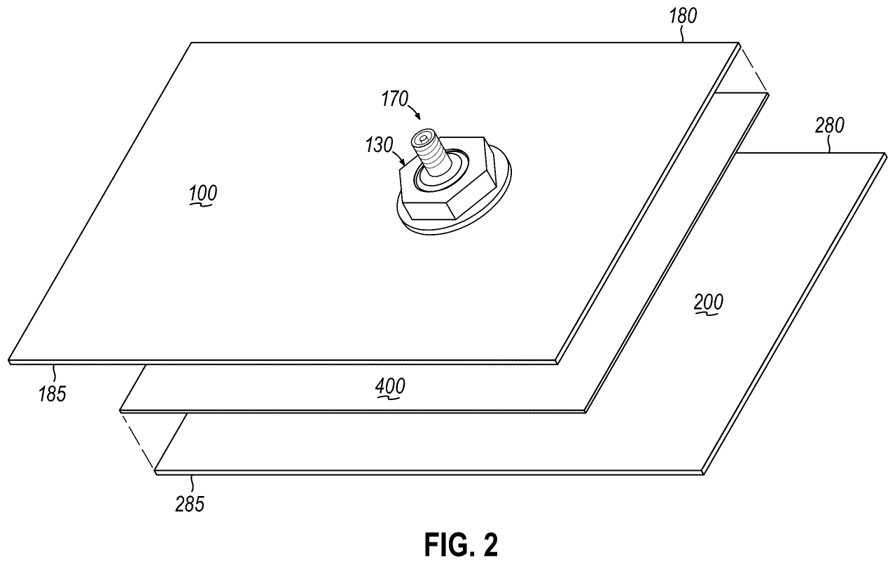

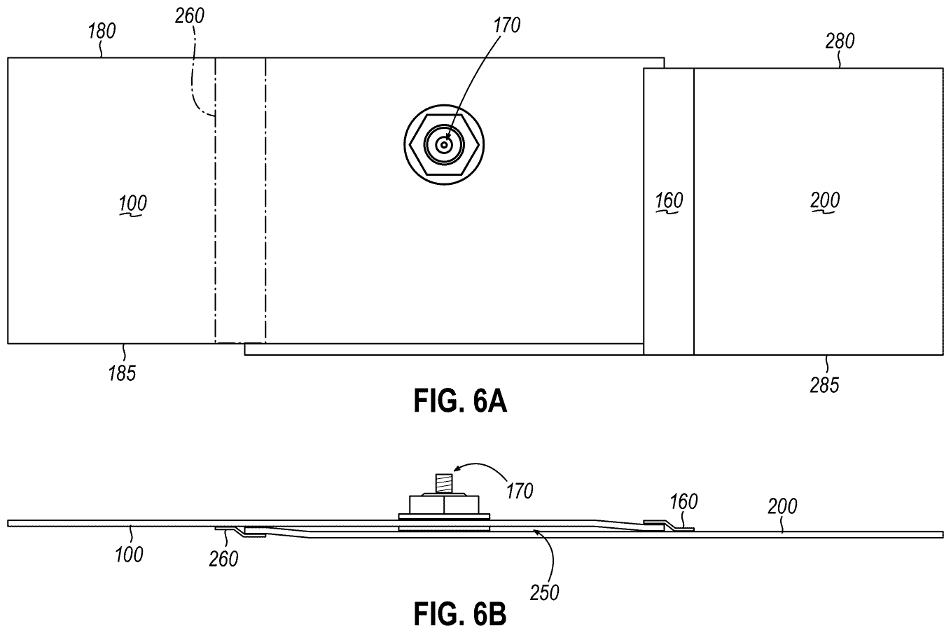

With reference to FIGS. 2 and 6A-6B, during assembly of a first fabric layer (100) to a second fabric layer (200), each fabric layer (100, 200) are overlapping such that tube (110) is approximately near the middle and the overlapping region as shown. When overlapped, upper edges (180, 280) of each fabric layer (100, 200) may be aligned with each other and each horizontal. Similarly, lower edges (185, 285) may also be aligned and each horizontal. The use of upper and lower is in reference to the ground and is similar to previous discussion upper vertical direction and lower vertical direction, respectively, where a liquid may first be in contact with lower edges (185, 285) before reaching upper edges (180, 280). As shown, valve (170) may be nearer upper edges (180, 280) than lower edges (185, 285).

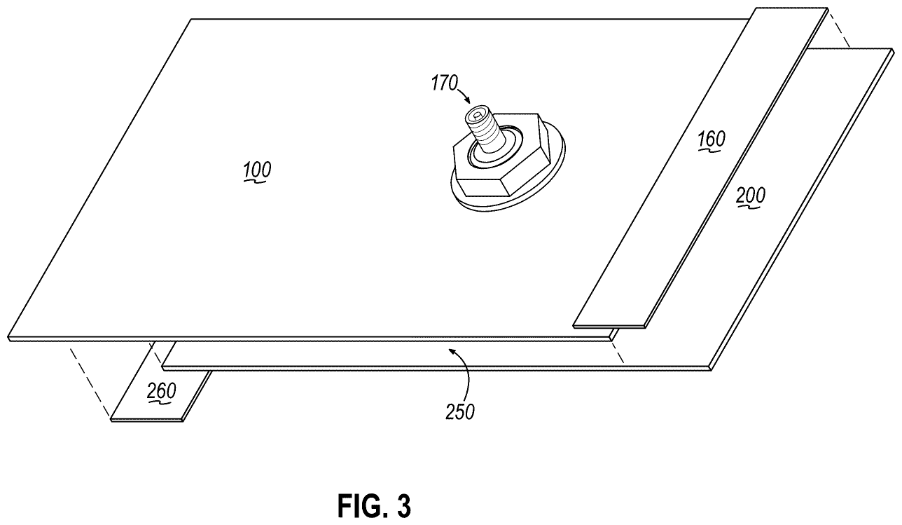

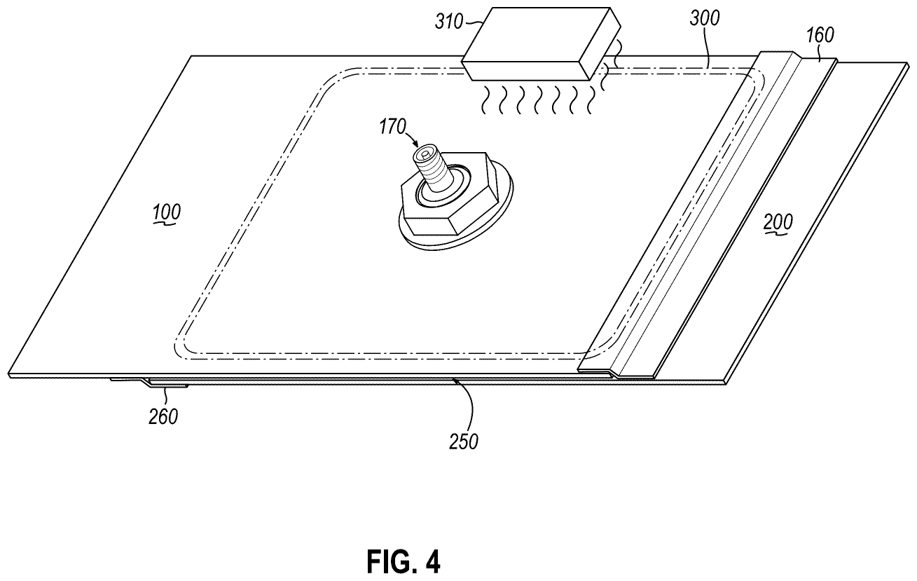

With reference to FIGS. 3 and 6A-6B, a first thin film (160) includes of a specific layer of film that is similar or the same in composition to the fabric layer (100) or may be an additional/alternative fabric layer. First thin film (160) is placed to overlap with both the first fabric layer (100) and the second fabric layer (200). Similarly, a second thin film (260) including an additional amount of the material used in the second fabric layer (200) is placed to overlap with both the second fabric layer (200) and the first fabric layer (100). The first fabric layer (100) and the second fabric layer (200) are then spliced together along a perimeter formed by the upper edges (180, 280), lower edges (185, 285) and sides of the first fabric layer (100) and the second fabric layer (200) as well the first thin film (160) and the second thin film (260), as clearly shown in FIGS. 4 and 6A-6B. This splice (300) results in the first fabric layer (100) and the second fabric layer (200) defining an interior pocket space (250), which is intended to be hermetically sealed.

Splicing for splice (300) may occur by applying an iron (310) heated to approximately 400 degrees F. to the intended splicing area along the perimeter. A scrap piece of material or TEFLON® (not shown) may be positioned between iron (310) and fabric layers (100, 200) and films (160, 260) to thereby prevent direct contact from iron (310). A roller or object may be applied to a backside of iron (310) to thereby apply a pressure against fabric layers (100, 200) and films (160, 260). Once spliced, iron (310) may be rocked side to side and back and form to thereby peel it from the melted fabric layers (100, 200) and films (160, 260). Once iron (310) has been removed, a roller (not shown) may thereafter be used to apply additional pressure to fabric layers (100, 200) and films (160, 260) as then cool.

The above splicing process may be repeated across the entire perimeter to thereby create interior pocket space (250). Since the side edge of second fabric layer (200) may not be visible to a user due to abutment of a tank, the user may mark first fabric layer (100) with an indicia indicating the side edge of second fabric layer (200).

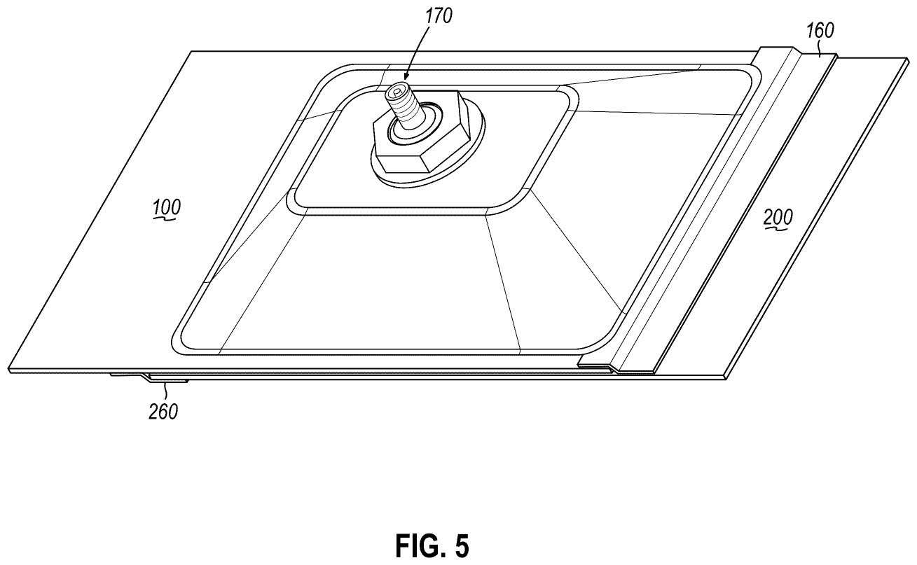

To detect whether the interior pocket space (250) is indeed hermetically sealed, a quality assurance test may be performed. In order to detect a failure to form a hermetically sealed interior pocket space (250), pressurized air may be injected into the interior pocket space (250) via the valve (170). If the interior pocket space (250) inflates, as shown in the schematic in FIGS. 5 and 7B, it is a confirmation that the splicing of the first fabric layer (100) and the second fabric layer (200) resulted in a hermetically sealed interior pocket space (250). If, however, the interior pocket space (250) fails to inflate, it is a confirmation that the interior pocket space (250) is not hermetically sealed, and there is a leak in the interior pocket space (250). To detect the precise location of the leak in the interior pocket space (250), a fluid, such as soapy water, or smoke from a smoke machine may be injected into the interior pocket space (250) via the valve (170). Once this fluid has entered the interior pocket space (250), it may exit the interior pocket space (250) through the leak, and accordingly, the leak may be precisely located, and perhaps repaired. Conversely, a fluid, such as soapy water, can be sprayed or applied externally at the location of the hermetic seal, thus indicating areas of leaks escaping the interior pocket space (250) when bubbles are formed from air escaping the interior pocket space (250). Interior pocket space (250) may be tested to approximately 1 psi of pressure.

As described above, the first fabric layer (100) is made of a first material and the second fabric layer (200) is made of a second material. Particularly, the first fabric layer (100) may be a first polyethylene firm layer, and the second fabric layer (200) may be a second polyethylene film layer. These polyethylene film layers provide chemical compatibility of petroleum product received thereagainst as well as resistance to abrasion to reduce the likelihood of wear, cuts and tears during use. In some examples, a polyester scrim layer (400) may be included within the interior pocket space (250), between the first fabric layer (100) and the second fabric layer (200). The polyester scrim layer (400) may be a woven material, such as fabric fibers, is shown sandwiched between polyethylene film layers and may be manufactured collectively as coated fabric in a continuous roll. In one example, the polyester scrim layer (400) and polyethylene film layers are secured together by lamination or splicing through heat, although alternative securement may be performed such that the invention is not intended to be limited to laminating or splicing the polyester scrim layer (400) and polyethylene film layers together. In one example, other materials, such as polytetrafluoroethylene (PTFE) or polyurethane may be similarly used. The invention is thus not intended to be limited to the particular arrangement of polyethylene film layers as shown in the present example.

Polyethylene film layers of the present example may include either ultra high molecular weight polyethylene or low density polyethylene. The ultra high molecular weight polyethylene may also be referred to herein as UHMW polyethylene, and is a form of polyethylene with excellent abrasion resistance and excellent friction reduction qualities. In contrast to a larger thickness being limited in size, shape, and flexibility, in one example, each UHMW polyethylene film layer has a predetermined layer thickness configured to be relatively flexible for foam log seal applications while retaining sufficient durability for use in the above ground storage tank industry. To this end, in one example, each UHMW polyethylene film layer has a thickness greater than approximately 0.001 inch. In one example, each UHMW polyethylene film layer has a thickness less than approximately 0.25 inch. In one example, each UHMW polyethylene film layer has a thickness of approximately 0.001 inch to approximately 0.125 inch. In one example, each UHMW polyethylene film layer has a thickness of approximately 0.007 inch to approximately 0.055 inch. In one example, each UHMW polyethylene film layer has a thickness of approximately 0.012 inch. In one example, each UHMW polyethylene film layer has a thickness of approximately 0.001 inch to approximately 0.007 inch. In one example, each UHMW polyethylene film layer has a thickness of approximately 0.007 inch to approximately 0.012 inch. In one example, each UHMW polyethylene film layer has a thickness of approximately 0.012 inch to approximately 0.055 inch. In one example, each UHMW polyethylene film layer has a thickness of approximately 0.055 inch to approximately 0.125 inch. While the above examples have each UHMW polyethylene film layer with like predetermined layer thicknesses, and in at least one example same predetermined layer thicknesses, such UHMW polyethylene film layer may be different in other examples. The invention is thus not intended to be limited to the predetermined layer thickness of first UHMW polyethylene film layer having a same predetermined layer thickness of second UHMW polyethylene film layer.

Collectively, in view of the above predetermined layer thickness of each UHMW polyethylene film layer, the arrangement of polyethylene film layer with polyester scrim layer as coated fabric has a collective predetermined material thickness of greater than approximately 0.02 inches. In one example, polyethylene film layer with polyester scrim layer as coated fabric has a collective predetermined material thickness of less than approximately 0.5 inches. In one example, polyethylene film layer with polyester scrim layer as coated fabric has a collective predetermined material thickness of approximately 0.02 inches to approximately 0.5 inches. In one example, polyethylene film layer with polyester scrim layer as coated fabric has a collective predetermined material thickness of approximately 0.020 inches. In one example, polyethylene film layer with polyester scrim layer as coated fabric has a collective predetermined material thickness of approximately 0.035 inches. Again, such predetermined thickness is generally thick enough to provide sufficient durability for use in the above ground storage tank industry while remaining sufficiently flexible for such applications, including foam log applications and other such applications as those described herein.

While the above example describes a fabric assembly and method of splicing same for use with petroleum and UHMW fabric materials, such fabric assembly and method may be used with any other fluid, liquid or gas. In one example, such fabric assembly may be incorporated into an above ground storage tank to reduce gaseous emissions to the atmosphere as associated with such evolved gases to be controlled, including but not necessarily limited to, crude oil, gasoline, jet fuel, ethanol, benzene, toluene, etc. In another example, such fabric assembly may be incorporated into another industry, such as splicing any other fabrics for assembly, such as a fabric splice for a vinyl swimming pool. The invention is therefore not intended to be unnecessarily limited to use with petroleum and UHMW fabric materials.

### II. ILLUSTRATIVE EXAMPLES

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A method of splicing and testing a liquid-mounted seal sheet, the method comprising: (a) overlapping a first fabric layer comprising a first material and a second fabric layer comprising a second material, wherein at least one of the first fabric layer or the second fabric layer defines an opening having a shaft defining a channel positioned therethrough, the shaft housing a valve having an open position and a closed position, wherein the valve is configured to allow a fluid through the channel in a first direction while the valve is in the open position, and the valve prevents the fluid through the channel while the valve is in the close position; (b) placing an additional amount of the first material to overlap the first fabric layer and the second fabric layer, and placing an additional amount of the second material to overlap the second fabric layer and the first fabric layer; (c) splicing the first fabric layer to the second fabric layer to form a spliced fabric composite comprising an interior pocket space defined by the first fabric layer and the second fabric layer; and (d) injecting a first fluid into the interior pocket space via the channel to thereby test a seal of the interior pocket.

### Example 2

The method of Example 1, wherein at least one of the first material or the second material comprises low-density polyethylene.

### Example 3

The method of any one or more of Examples 1 through 2, wherein at least one of the first material or the second material comprises ultra-high-molecular-weight polyethylene.

### Example 4

The method of Example 3, wherein splicing the first fabric layer to the second fabric layer comprises heat splicing the first fabric layer to the second fabric layer.

### Example 5

The method of Example 4, wherein splicing the second fabric layer to the first fabric layer comprises heat splicing the second fabric layer to the first fabric layer.

### Example 6

An apparatus, comprising: (a) a spliced fabric composite, including: (i) a first fabric layer, (ii) a second fabric layer spliced to the first fabric layer, wherein the first fabric layer and the second fabric layer are different, and (iii) an interior pocket space defined by the first fabric layer and the second fabric layer; and (b) a valve extending through at least one of the first or second fabric layer in fluid communication with the interior pocket space.

### Example 7

The apparatus of Example 6, further including a first thin film positioned to overlap and contact each of the first and second fabric layers.

### Example 8

The apparatus of Example 7, wherein the first thin film and the first fabric layer each include a first material.

### Example 9

The apparatus of Example 8, further including a second thin film positioned to overlap and contact each of the first and second fabric layers on an opposing side from the first thin film.

### Example 10

The apparatus of Example 9, wherein the second thin film and the second fabric layer each include a second material which is different from the first material.

### Example 11

The apparatus of any one or more of Examples 9 through 10, wherein the second thin film is positioned on an opposing end of the interior pocket space from the first thin film.

### Example 12

The apparatus of any one or more of Examples 9 through 11, wherein each of the first thin film and the second thin film are configured to melt into each of first and second fabric layers to thereby hermetically seal the interior pocket space.

### Example 13

The apparatus of any one or more of Examples 6 through 12, further including a polyester layer positioned between the first and second fabric layers.

### Example 14

The apparatus of any one or more of Examples 6 through 13, the valve comprising a threaded shaft, a nut, and a flange.

### Example 15

The apparatus of Example 14, wherein the flange is positioned between the first and second fabric layers.

### Example 16

A method of manufacturing a fabric assembly, the method comprising overlapping a first fabric layer comprising a first material and a second fabric layer comprising a second material, wherein at least one of the first fabric layer or the second fabric layer defines an opening having a shaft defining a channel positioned therethrough, the shaft housing a valve having an open position and a closed position, wherein the valve is configured to allow a fluid through the channel in a first direction while the valve is in the open position, and the valve prevents the fluid through the channel while the valve is in the close position.

### Example 17

The method of Example 16, further comprising: (a) placing an additional amount of the first material to overlap the first fabric layer and the second fabric layer, and placing an additional amount of the second material to overlap the second fabric layer and the first fabric layer.

### Example 18

The method of any one or more of Examples 16 through 17, further comprising: (a) splicing the first fabric layer to the second fabric layer to form a spliced fabric composite comprising an interior pocket space defined by the first fabric layer and the second fabric layer.

### Example 19

The method of any one or more of Examples 16 through 18, further comprising injecting a first fluid into the interior pocket space via the channel.

### Example 20

The method of any one or more of Examples 16 through 19, further comprising injecting a second fluid into the interior pocket space via the channel.

### III. MISCELLANEOUS

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. A method of splicing and testing a liquid-mounted seal sheet, the method comprising:
(a) overlapping a first fabric layer comprising a first material and a second fabric layer comprising a second material, wherein at least one of the first fabric layer or the second fabric layer defines an opening having a shaft defining a channel positioned therethrough, the shaft housing a valve having an open position and a closed position, wherein the valve is configured to allow a fluid through the channel in a first direction while the valve is in the open position, and the valve prevents the fluid through the channel while the valve is in the close position;
(b) placing an additional amount of the first material to overlap the first fabric layer and the second fabric layer, and placing an additional amount of the second material to overlap the second fabric layer and the first fabric layer;
(c) splicing the first fabric layer to the second fabric layer to form a spliced fabric composite comprising an interior pocket space defined by the first fabric layer and the second fabric layer; and
(d) injecting a first fluid into the interior pocket space via the channel to thereby test a seal of the interior pocket.

2. The method of claim 1, wherein at least one of the first material or the second material comprises low-density polyethylene.

3. The method of claim 1, wherein at least one of the first material or the second material comprises ultra-high-molecular-weight polyethylene.

4. The method of claim 1, wherein splicing the first fabric layer to the second fabric layer comprises heat splicing the first fabric layer to the second fabric layer.

5. The method of claim 1, wherein splicing the second fabric layer to the first fabric layer comprises heat splicing the second fabric layer to the first fabric layer.

6. An apparatus, comprising:
(a) a spliced fabric composite, including:
(i) a first fabric layer,
(ii) a second fabric layer spliced to the first fabric layer, wherein the first fabric layer and the second fabric layer are different, and
(iii) an interior pocket space defined by the first fabric layer and the second fabric layer; and
(b) a valve extending through at least one of the first or second fabric layer in fluid communication with the interior pocket space.

7. The apparatus of claim 6, further including a first thin film positioned to overlap and contact each of the first and second fabric layers.

8. The apparatus of claim 7, wherein the first thin film and the first fabric layer each include a first material.

9. The apparatus of claim 8, further including a second thin film positioned to overlap and contact each of the first and second fabric layers on an opposing side from the first thin film.

10. The apparatus of claim 9, wherein the second thin film and the second fabric layer each include a second material which is different from the first material.

11. The apparatus of claim 9, wherein the second thin film is positioned on an opposing end of the interior pocket space from the first thin film.

12. The apparatus of claim 9, wherein each of the first thin film and the second thin film are configured to melt into each of first and second fabric layers to thereby hermetically seal the interior pocket space.

13. The apparatus of claim 6, further including a polyester layer positioned between the first and second fabric layers.

14. The apparatus of claim 7, the valve comprising a threaded shaft, a nut, and a flange.

15. The apparatus of claim 14, wherein the flange is positioned between the first and second fabric layers.

16. A method of manufacturing a fabric assembly, the method comprising overlapping a first fabric layer comprising a first material and a second fabric layer comprising a second material, wherein at least one of the first fabric layer or the second fabric layer defines an opening having a shaft defining a channel positioned therethrough, the shaft housing a valve having an open position and a closed position, wherein the valve is configured to allow a fluid through the channel in a first direction while the valve is in the open position, and the valve prevents the fluid through the channel while the valve is in the close position.

17. The method of claim 16, further comprising:
(a) placing an additional amount of the first material to overlap the first fabric layer and the second fabric layer, and placing an additional amount of the second material to overlap the second fabric layer and the first fabric layer.

18. The method of claim 16, further comprising:
(a) splicing the first fabric layer to the second fabric layer to form a spliced fabric composite comprising an interior pocket space defined by the first fabric layer and the second fabric layer.

19. The method of claim 18, further comprising injecting a first fluid into the interior pocket space via the channel.

20. The method of claim 19, further comprising injecting a second fluid into the interior pocket space via the channel.
